(19) United States
(12) Patent Application Publication
(10) Pub. No.: US 2003/0043204 A1
(43) Pub. Date: Mar. 6, 2003

(54) User interface for simultaneous duplicator scheduling

(76) Inventors: Jeffrey T. Aguilera, Nampa, ID (US); Keith Braunwalder, Eagle, ID (US)

Correspondence Address: HEWLETT-PACKARD COMPANY, Intellectual Property Administration, P. O. Box 272400, Fort Collins, CO, 80527-2400, US

(21) Appl. No.: 09/944,686

(22) Filed: Aug. 31, 2001

(51) Int. Cl. G09G 5/00

(52) U.S. Cl. 345/810

(57) ABSTRACT

Systems, methods and program products therefore are described herein for a user interface that simultaneously displays a plurality of actuatable icons each representing a duplicator that can be selected to perform a duplication function. Upon the completion of the selections, the selected duplicators simultaneously perform respective duplication functions.

### FIELD OF THE INVENTION

The present invention relates to a user interface, and more particularly to a single user interface display for the simultaneous actuation of multiple duplicators.

### BACKGROUND OF THE INVENTION

A duplicator reads an image and then writes the image that it read. Some duplicators read and write in analog, an example of which is a conventional office copier that scans or reads in a stack of image-bearing paper in a sheet feeder and then writes onto a respective stack of paper with a copier toner substance. Another example a duplicator that reads and writes in analog is a videocassette recorder (VCR), where the VCR reads a plurality of analog images from a broadcast television program and then writes an analog copy of the read analog images onto a magnetic tape. Still another example of a duplicator that reads and writes in analog is a film developing machine that passes light through an image-bearing film negative (e.g. reading the film) so as to write the image onto a photo imaging substrate for the production of positive image film, such a microfilm or microfiche. Some duplicators read an image digitally. An example of a duplicator that reads in a digital copy of an image is a device that has a sheet fed scanner that can scan in a stack of image-bearing paper while digitizing each image on each sheet of paper in the stack. Some duplicators can digitally read an image and then digitally write the image. Still other duplicators can read and write in both digital and analog formats.

Once a duplicator has a read an image, the duplicator can then write the image in several ways, depending upon the analog and digital writing capabilities of the duplicator. Examples of duplicators that can write in analog are printers, copiers, magnetic tape recorders, and photochemical image printers such as microfilm/microfiche writers. An example of a duplicator that can write digitally is a personal computer that can instigate a writing operation to a media storage device, such as a network server, a magneto optical writing device such as a compact disk (CD) writer, a digital video disk (DVD) writer, a video CD (VCD) writer, or a magnetic tape recorder. Other types of duplicator writing, which can be either digital or analog, are electromagnetic radiation projection on devices such as a video image projector and display devices, and an infrared or wireless radio wave broadcasting transmitter.

It is desirable to provide the multifaceted functional capabilities of duplicators to users of a computer network. When provided as network resources on a computer network, duplicators are considered to be peripherals or “dedicated purpose” devices. A multifunction peripheral (MFP), sometimes referred to as an “All-In-One”, combines two or more peripheral devices into a single device, such as printing, scanning, copying, and facsimile transmission.

When a user of a computer network is provided with access to duplicator network resources, the network user can make the choice to duplicate images using a particular duplicator network resource for both objective and subjective reasons. The objective reason for a user selecting one duplicator network resource over another may be due to their respective capabilities. For instance, some printers are slow, noisy, and have poor writing quality, such as dot matrix printers. Other printers have numerous and complex capabilities. Examples of complex printer capabilities include high quality photo reproduction, multi-section reports with tabs, in-line mixed material insertion such as insertion of full-color preprinted copies and digital color-page insertion. Other complex printer capabilities include printing on substrates of varied composition, such as embossed, heavy-weight, multi-weight, and cover paper stock, as well as carbonless paper, blue prints, clear or colored transparency printing, and other specialty stock including preprinted offset color covers. Still other complex printer capabilities includes binding, collating, folding, stacking, stapling, stitching such as saddle stitching, edge-trimming, paginating for multi-language, and inline pagination and annotation.

A user may wish to read an image using one duplicator network resource and then write the image using a different duplicator network resource. Reasons for doing so may be the availability of remote service diagnostics for a particular duplicator network resource or because a particular duplicator reads and/or writes faster than others, is physically closer to the user, or is simply less expensive to operate in a particular fashion such as writing in gray scale or color. Of course a user may select a duplicator on the network for purely subjective reasons.

When a project requires complex reading and writing of multiple images, several duplicator network resources might be required, each having different reading and writing capabilities needed for the project. By way of example, a network user may wish to publish a manuscript for distribution through a variety of channels. Consider the tasks undertaken by the network user who has the manuscript fixed as images on a stack of multi-sized sheets of paper. First, the network user places the stack of multi-sized paper in a sheet feeder of a duplicator having the capability of handling multi-sized paper. Then the network user calls up the first of many user interfaces on a computer display that are needed to begin, follow through, and complete the manuscript distribution project. For instance, the project may involve both analog and digital reading of the stack of multi-sized paper, then writing the images in both color and gray scale on various paper sizes in stapled and/or bound form, writing transparencies for an overhead projector presentation, transmitting the manuscript by email and by telephone facsimile transmission, writing a read-only CD bearing a digital version of the manuscript images, and writing a digitally editable backup of the manuscript on a portable read/write media storage container.

The network user must plan for the use of several duplicator network resources that are required for the manuscript distribution project. Each duplicator network resource must be scheduled by the network user sequentially, one after the other, by using a series of different user interfaces. Due to the nature of the multiple and different user interfaces employed by the network user for the project, the network user may need to wait for each duplicator network resource to complete its duplication function before scheduling the next duplicator network resource. With so many network duplicator resources required for the distribution project, as well as multiple functions called for within some of the duplicator network resources, the network user's efforts in scheduling a plurality of tasks for each of several duplicator network resources, sequentially and one at a time, each scheduled task requiring the use of a separate user interface, is an inefficient use of the network user's time.

Another inefficiency problem is found in typical print function user interfaces, such as in typical personal computer environments, which allow a user to select only one printer at a time. If a user wants to print on more that one printer, the user must recall the same user interface for each print job on each printer. Like the foregoing example, inefficiency exists for the user in that repetitive operations are required. It would be an advantage in the art to make more efficient use of a user's time when scheduling duplication tasks, such as printing, for multiple duplicator network resources.

### SUMMARY OF THE INVENTION

In one embodiment, a user interface simultaneously displays a plurality of actuatable icons, each representing a duplicator, that when actuated simultaneously actuates the respective duplicator.

These and other features of the present invention will become more fully apparent from the following description and appended claims, or may be learned by the practice of the invention as set forth hereinafter.

### DESCRIPTION OF THE DRAWINGS

To further clarify the above and other advantages and features of the present invention, a more particular description of the invention will be rendered by reference to specific embodiments thereof which are illustrated in the appended drawings. The same numbers are used throughout the drawings to reference like features and components. It is appreciated that these drawings depict only typical embodiments of the invention and are therefore not to be considered limiting of its scope. The invention will be described and explained with additional specificity and detail through the use of the accompanying drawings in which:

FIG. 1 illustrates a host computer having local access to a duplicator and in a system environment suitable for providing remote access to a plurality of duplicator network resources.

FIG. 2 is a block diagram illustrating a host computer in a system such as that shown in FIG. 1.

FIG. 3 illustrates an example of a user interface menu page that might be displayed on a display screen of a host computer.

FIG. 4 is a flow diagram illustrating an example of a method of displaying and activating a menu page on a display screen of a host computer.

### DETAILED DESCRIPTION

The user interfaces, systems, methods, and program products described herein relate to the presentation of a display screen upon which a network user can simultaneously specify and actuate duplicator related tasks to be performed by multiple duplicators.

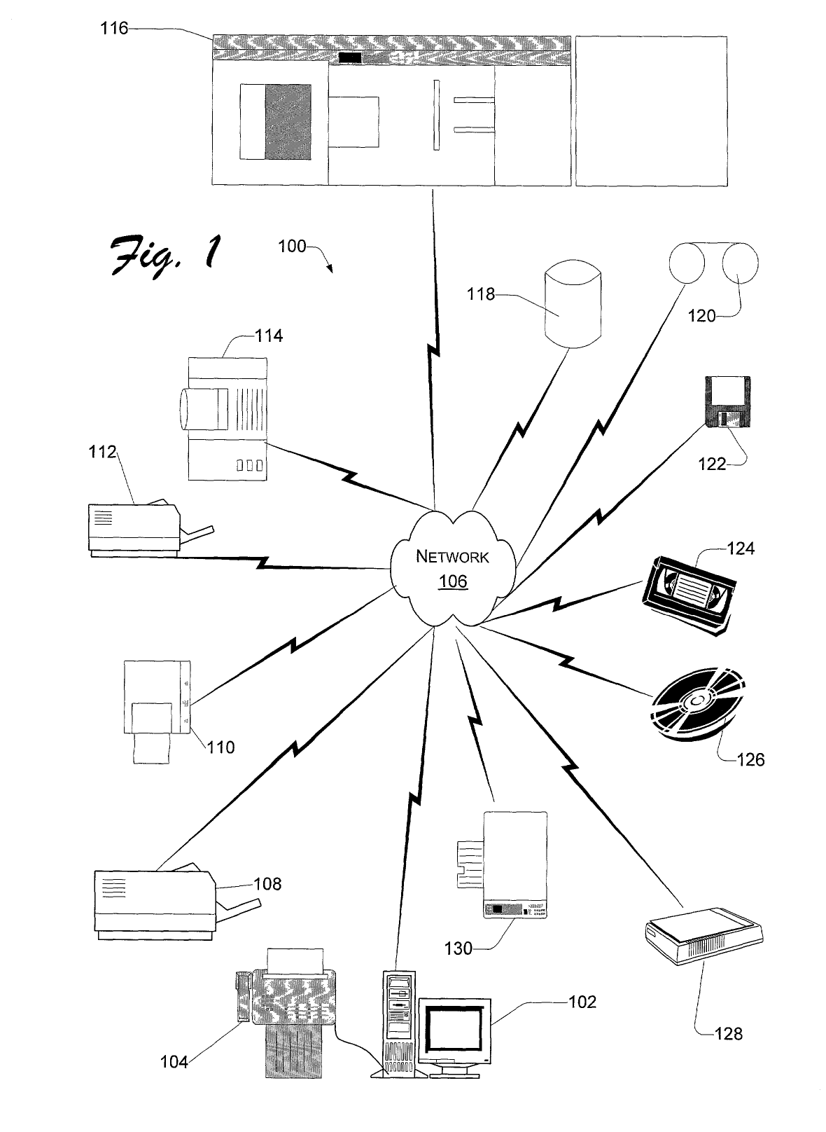

FIG. 1 illustrates an example of a system environment 100 suitable for implementing a multiple duplicator selection menu screen on a display device associated with a host computer 102. The system environment 100 provides host computer 102 with local access to a multifunction peripheral (MFP) 104, sometimes referred to as an “All-In-One”. MFP 104 has the capabilities of reading a stack of image-bearing paper with its sheet fed scanner, writing a duplicate of the scanned images with its printer function, or sending a duplicate of the scanned pages with its facsimile transmission function over a telephone system (not shown). MFP 104 can also function as a color printer to print out data transmitted from host computer 102.

The system 100 of FIG. 1 illustrates host computer 102 as being coupled to a plurality of duplicator network resources 102-130 through a network connection 106 that can include LANs (local area networks), WANs (wide area networks), an intranet, the Internet, or any other suitable communication link.

In general, the host computer 102 outputs host data locally to MFP 104 in a driver format suitable for the MFP 104, such as PCL or postscript for the printer function of MFP 104. MFP 104 converts the host data and outputs it onto an appropriate print media, such as paper, transparencies or glossy photo paper.

Host computer can also output host data remotely to duplicator network resources 108-130 through network connection 106. The duplicators seen in FIG. 1 include a black and white desk top laser printer 108, a plotter 110, a color laser printer 112, a digital video display projector 114, and a high volume copier 116 that includes the capabilities of printing on substrates of varied composition, binding, collating, folding, stacking, stapling, stitching, edge-trimming, and paginating. Also seen in FIG. 1 at reference numerals 118-130 are various representations of other kinds of duplicators, including a network server 118, a tape drive 120, a diskette drive 122, a VCR 124, a magneto optical read and write device 126 for reading and writing compact disks, a scanner 128 that has the capability of reading scanned images and storing them on a portable media storage device locally associated therewith, and a standard desktop copier 130. Host computer 102 can actuate duplication tasks on any of the duplicators seen in FIG. 1.

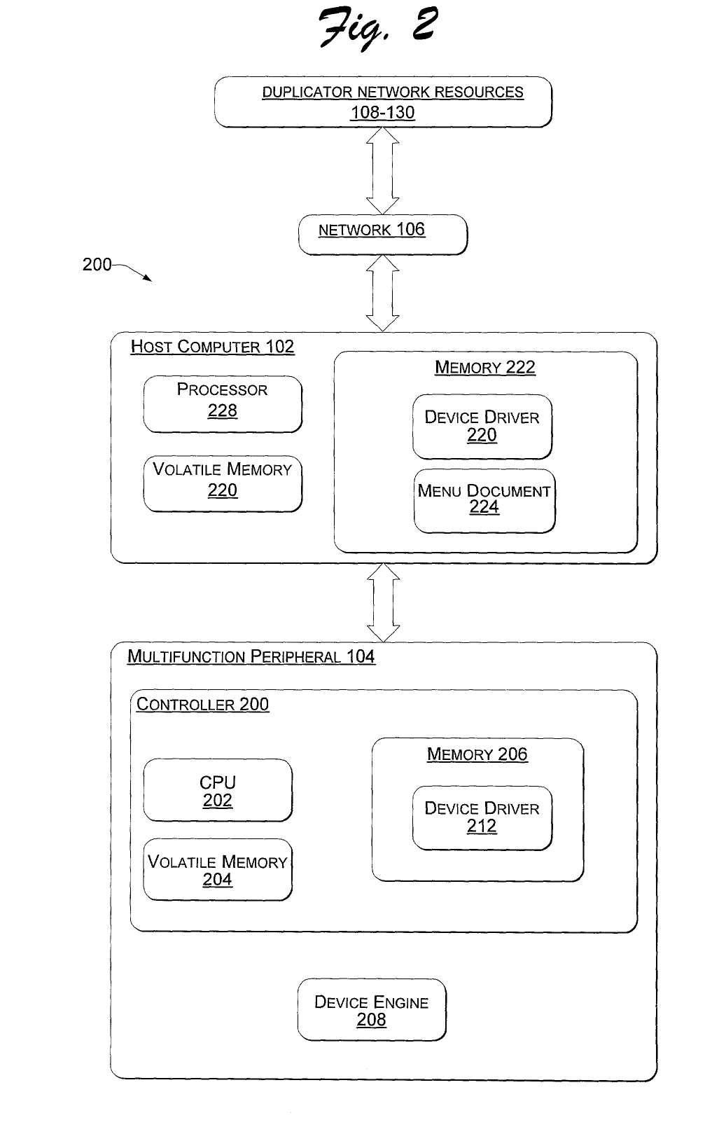

FIG. 2 illustrates an embodiment of the system 100 of FIG. 1 in greater detail. Host computer 102 includes a processor 228, a volatile memory 220 (i.e., RAM), and a non-volatile memory 222 (e.g., ROM, hard disk, floppy disk, CD-ROM, etc.). The host computer 102 may be implemented, for example, as a general-purpose computer, such as a desktop personal computer, a laptop, a server, and the like. The host computer 102 may implement one or more software-based device drivers 220 that are stored in non-volatile memory 222 and executed on the processor 228 to configure data into an appropriate format (e.g., PCL, postscript, etc.) and output the formatted data to MFP 104. A device driver 220 and a menu document 224 area in volatile memory 222 stores a representation of each of the duplicator network resources 108-130 and their respective capabilities, both of which a user can select using a user interface that is displayed upon the display screen of host computer 102.

The multifunction peripheral (MFP) 104 has a device controller 200 that processes the host computer 102 data. The controller 200 typically includes a data processing unit or CPU 202, a volatile memory 204 (i.e., RAM), and a non-volatile memory 206 (e.g., ROM, Flash). The device controller 200 processes host data and manages device functions by controlling the device engine 208. Controller 200 includes device driver software 212 stored in memory 206 and executed on CPU(s) 202. Within system 100 of FIG. 1, the MFP 104 is accessible locally by host computer 102 executing an application. A connection to network 106 is seen in FIG. 2 between host computer 102 and duplicator network resources 108-130. As such, host computer 102 can actuate duplication functions remotely on any of duplicator network resources 108-130.

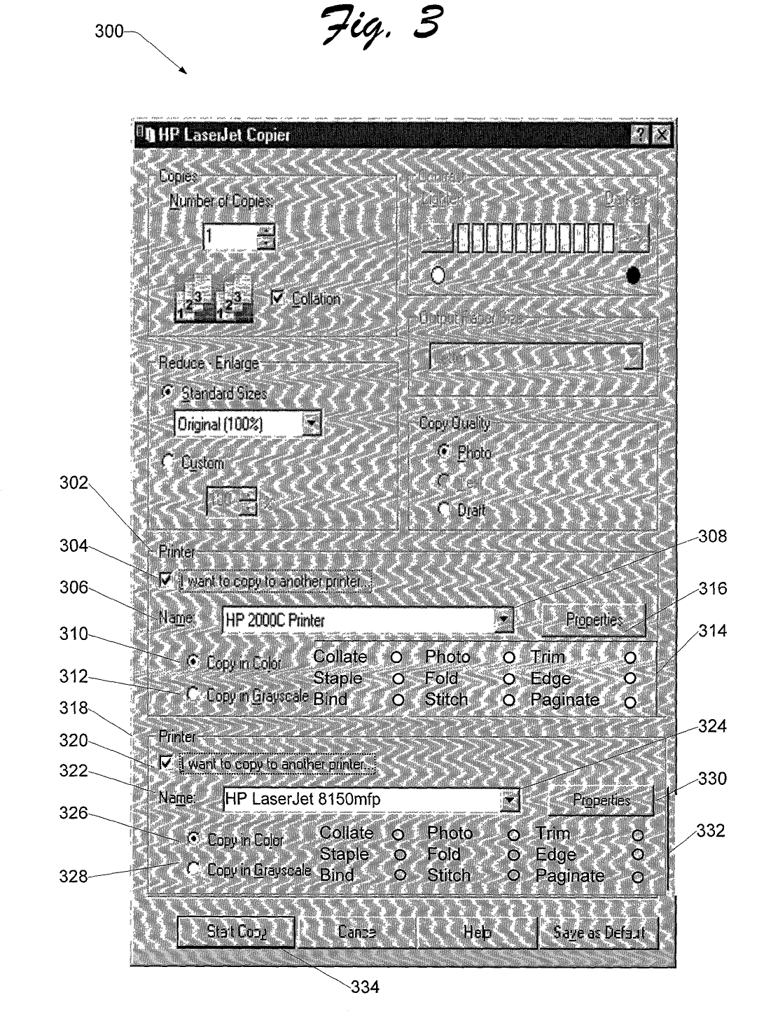

FIG. 3 illustrates an example menu page 300 that might be displayed on the display screen of host computer 102 of FIGS. 1-2. The menu page 300 is displayed when a user initiates a duplication function that is directed to MFP 104, such as scanning, copying, printing, or sending a facsimile transmission. In the illustrated implementation, menu page 300 has two dialog boxes 302, 318 that allow the user to select, in addition to MFP 104, two different duplicator network resources. Of course, different menu page designs are contemplated that could allow a user to select not only MFP 104, but also any number of additional duplicator network resources.

A selection of each duplicator network resource can be made by keying in a check mark into an appropriate display box or radio button, such as radio buttons 304 and 320, respectively for dialog boxes 302 and 318. In a Microsoft WINDOWS® environment, a selection can be made by a “point-and-click” mouse function.

Pull down menus 308, 324 allow for the selection of any of duplicator network resources 108-130 which will in turn cause the name of the selected duplicator to appear in boxes 306, 322. Color and grayscale choices are offered as printing and scanning choices in radio buttons 310, 312, 326, and 328. Various properties of duplicator network resources 108-130 can be queried and edited using the dialog box which is launched after the point-and-click of buttons 316, 330. Tasks to be performed by the selected duplicator network resources 108-130 are selected by the user checking each appropriate radio button in the task dialog boxes 314, 332 for a respective duplicator network resource selected in 306 and 322.

In one implementation, the tasks that are displayed in the task dialog boxes 314, 332 are a function of the particular duplicator that was selected from pull down menus 308, 324. In another implementation, the displayed selections in task dialog boxes 314, 332 are hard coded and invariable.

Once all of the duplication network resources and respective tasks for each duplicator have been selected for each menu item upon user interface menu 300, the user then actuates these duplicators to commence duplication as per the selected respective tasks, such as by point and clicking upon menu selection 334 seen in FIG. 3 with the label “Start Copy”. The result of this actuation of menu selection 334 will be the actuation of the initially selected task for MFP 104 and simultaneously therewith the actuation of the selected tasks in task dialog boxes 314, 332 for duplicator network resources 306, 322.

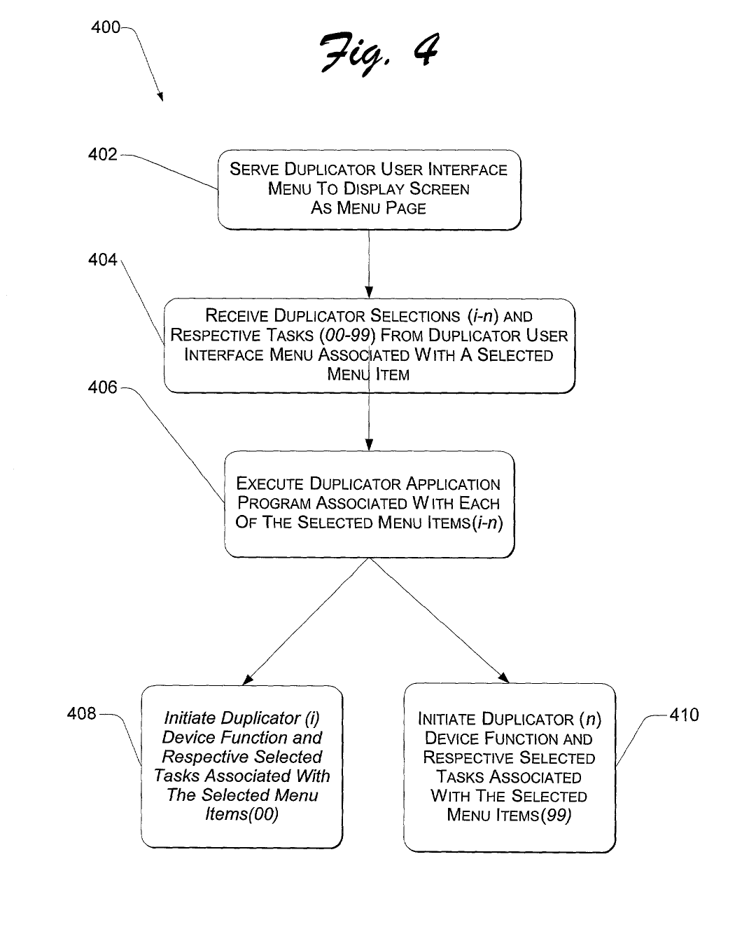

Example methods for implementing a multiple duplicator actuation user interface menu screen will now be described with primary reference to FIG. 4. The methods apply generally to duplicator network resources 108-130 of FIGS. 1-2. FIG. 4 is a flow diagram 400 that shows an example of a general method for displaying a multiple duplicator actuation user interface menu screen and activating a menu page on a display device of host computer 102. At block 402, host computer 102 serves up a duplicator user interface menu for display upon the display device of host computer 102, such as upon a video display terminal of a cathode ray tube. Block 402 will preferably be executed upon the selection by a user of host computer 102 to perform a function using MFP 104, such as copying or ‘faxing’. Prior to block 404 being executed, the user keys in selections and respective tasks for one or more duplicator network resources 108-130 as was discussed above with respect to FIG. 3. At block 404 the host computer 102 receives the user's menu selections for duplicator network resources ‘i’ to ‘n’ and for tasks ‘00’ though ‘99’ for each respective duplicator network resources from ‘i’ to ‘n’. At block 406 the task execution instructions for tasks ‘00’ though ‘99’ are transmitted to selected duplication network resources ‘i’ to ‘n’ through network connect 106 seen in FIGS. 1-2. At block 408, boxes 408, 410 indicate that there are initiated the selected tasks ‘00’ though ‘99’ for performance upon the selected duplication network resources ‘i’ to ‘n’ according to the user's selections provided upon the user interface display screen of FIG. 3.

While the forgoing example describes a network environment, it is also contemplated that the user interface can permit the simultaneous selection and actuation of multiple duplicators that are not remotely accessed through a network by a host computer, but rather are locally accessed by the host computer without the benefit of a network connection. By way of example, a host computer may have a hub of Universal Serial Bus (USB) port connections to a plurality of duplicators that are physically present with the host computer, each of which can be simultaneously actuated to perform respectively selected tasks through a user's selections within a user interface that is displayed as a single menu screen upon the display device of the host computer. When so used, multiple duplicators simultaneously commence duplication tasks when the user sends the selections to the host computer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A user interface comprising a simultaneous display of a plurality of actuatable icons, each representing a duplicator, that when actuated simultaneously actuates the respective actuated duplicator.

2. The user interface as defined in claim 1, wherein:
the simultaneous display of the plurality of actuatable icons is a menu screen; and
each said actuatable icon is a menu item.

3. The user interface as defined in claim 1, wherein one said duplicator is a default duplicator that, upon the selection of another said duplicator by actuation of the respective actuatable icon thereof, said default duplicator:
scans an image;
records the scanned image and electronically communicates the recorded image for the duplication thereof on said another said duplicator.

4. The user interface as defined in claim 1, wherein the actuation of the respective duplicators occurs in a chronological sequence selected by the user on the UI.

5. The user interface as defined in claim 1, wherein the actuation of the respective duplicators selected by a user on the UI occurs simultaneously.

6. The user interface as defined in claim 1, wherein the UI displays a choice for selection of actuation of the respective duplicators chronologically, sequentially, or both.

7. The user interface as defined in claim 1, wherein one said duplicator is a default duplicator that, upon the selection of another said duplicator by a user designation of one or more of said actuatable icons the UI:
scans an image;
records the scanned image and electronically communicates the recorded image for the printing thereof on said another said duplicator selected by the user on the user interface.

8. The user interface as defined in claim 1, wherein each said duplicator has the capability of performing one or more functions selected from the group consisting of printing, magnetic tape recording, photo imaging substrate recording, recording an optically scanned image onto a magnetic media storage device, magneto optical writing, and electromagnetic radiation broadcasting transmission.

9. The user interface as defined in claim 8, wherein the printing is performed by a printer having the capability of performing one or more functions selected from the group consisting of dot matrix printing, thermal ink jet printing, laser printing, color printing, high quality photo reproduction, printing on substrates of varied composition, binding, collating, folding, stacking, stapling, stitching, edge-trimming, and paginating.

10. A user interface having multiple duplicator selections displayed upon a single display screen that, when actuated after selection by a user, initiates duplication tasks on each of the user selected duplicators.

11. The user interface as defined in claim 10, wherein each said duplicator has the capability of performing one or more functions selected from the group consisting of printing, magnetic tape recording, photo imaging substrate recording, recording an optically scanned image onto a magnetic media storage device, magneto optical writing, and electromagnetic radiation broadcasting transmission.

12. The user interface as defined in claim 11, wherein the printing is performed by a printer having the capability of performing one or more functions selected from the group consisting of dot matrix printing, thermal ink jet printing, laser printing, color printing, high quality photo reproduction, printing on substrates of varied composition, binding, collating, folding, stacking, stapling, stitching, edge-trimming, and paginating.

13. The user interface as defined in claim 11, wherein one said actuated duplicator is a default duplicator that, upon the actuation thereof:
scans and records an image; and
electronically communicates the recorded image for the printing thereof on another duplicator selected by the user on the user interface.

14. A method for displaying a user interface, the method comprising:
serving a user interface for display as a menu page, the menu page having a simultaneous display of a plurality of actuatable menu items for selection by a user each representing a duplicator that, when actuated by said selection, actuates the respective duplicator; and
upon the actuation of one said actuatable menu item by said selection:
recording an image with a default duplicator by a scanning capability thereof; and
communicating the recorded image to each duplicator corresponding to each actuatable menu item selected on the user interface for duplication on each respective duplicator.

15. The method as defined in claim 14, wherein the recording of the image comprises recording the scanned image with a media-recording device in communication with the host computer.

16. The method as defined in claim 14, wherein the recording of the image comprises recording the scanned image with a media-recording device integral to the default duplicator.

17. The method as defined in claim 14, wherein each said duplicator to which the recorded image is communicated has the capability of performing one or more functions selected from the group consisting of printing, magnetic tape recording, photo imaging substrate recording, recording an optically scanned image onto a magnetic media storage device, magneto optical writing, and electromagnetic radiation broadcasting transmission.

18. The method as defined in claim 17, wherein the printing is performed by a printer having the capability of performing one or more functions selected from the group consisting of dot matrix printing, thermal ink jet printing, laser printing, color printing, high quality photo reproduction, printing on substrates of varied composition, binding, collating, folding, stacking, stapling, stitching, edge-trimming, and paginating.

19. A computer-readable media containing computer-executable instructions that, when executed on a computer, performs the method as defined in claim 14.

20. A system for duplicating an image upon multiple duplicators in communication with a host computer, a method comprising:
serving a single user interface for display as a menu page on a screen of a display terminal in communication with the host computer, the menu page having a simultaneous display of a plurality of actuatable menu items selectable by a user each representing a duplicator in communication with the host computer that, when actuated, actuates the respective duplicator; and
executing an application program on the host computer upon the actuation of one said actuatable menu item selected by the user to:
record an image with a default duplicator by a scanning capability thereof, and
communicate the recorded image to each said duplicator corresponding to each actuatable menu item selected on the user interface for the respective duplication thereof.

21. The system as defined in claim 20, wherein:
each said duplicator and the host computer are in communication through a network;
the scanned image is communicated through the network for recording on a media storage device in communication with the network; and
the recorded image is communicated through the network from said media storage device to each said duplicator corresponding to each actuatable menu item selected on the user interface.

22. The system as defined in claim 20, wherein each said duplicator to which the recorded image is communicated has the capability of performing one or more functions selected from the group consisting of printing, magnetic tape recording, photo imaging substrate recording, recording an optically scanned image onto a magnetic media storage device, magneto optical writing, and electromagnetic radiation broadcasting transmission.

23. The system as defined in claim 20, wherein the printing is performed by a printer having the capability of performing one or more functions selected from the group consisting of dot matrix printing, thermal ink jet printing, laser printing, color printing, high quality photo reproduction, printing on substrates of varied composition, binding, collating, folding, stacking, stapling, stitching, edge-trimming, and paginating.
